(19) United States
(12) Patent Application Publication
(10) Pub. No.: US 2016/0047147 A1
(43) Pub. Date: Feb. 18, 2016

(54) AUTOMOTIVE DOOR HINGE SAFETY LOCK

(71) Applicant: Aaron D. James, Laguna Hills, CA (US)

(72) Inventor: Aaron D. James, Laguna Hills, CA (US)

(21) Appl. No.: 14/458,498

(22) Filed: Aug. 13, 2014

(51) Int. Cl. E05B 81/20; E05C 17/02

(52) U.S. Cl. CPC E05B 81/21; E05C 17/02

(57) ABSTRACT

A door lock device including a hinged pivotal detent arm formed with a detent engageable with a lock pin to hold the door in an open position and a latch operative in response to an object in a doorway to latch the pin device in the detent.

### BACKGROUND

1. Field of the Invention

The present invention relates to vehicle door locks and particularly to a lock for a hinged door to selectively hold it in an open position.

2. Description of the Prior Art

Vehicle doors such as those used in passenger automobiles, trucks, vans, tractors and related vehicles often include doors carried on hinges to be closed on their free sides to engage a latch on the frame of the vehicle. These doors can be relatively heavy so the forces generated by the momentum of closing a door can be considerable.

All too often, either the front or back door of a vehicle will be driven unexpectedly towards its closed position to strike the passenger seeking to exit the passenger seat. This problem is exacerbated when the passenger is in any way physically impaired this imposing additional loads on their care giver involved in the task of transporting the patient. Safety issues have been encountered with such doors, such as accidental closing on a passenger or the like causing pinching of a body part or other injury.

In recognition of the desire to avoid injury to passengers during the loading and unloading process, it has been proposed to provide a sensing mechanism for sensing when a passenger is in the doorway to automatically actuate a blocking device to block the door against full closure to thereby prevent pinching of a passenger's hand or fingers. A device of this type is shown in U.S. Pat. No. 5,074,073 to Zwebner.

Other efforts to block full closure of the door to prevent injury during the loading and unloading of passengers has led to the proposal of a solenoid housed in a well in the doorframe to project a blocking wedge against the door when a sensor detects a passenger entering or leaving the vehicle. A device of this type is shown in U.S. Pat. No. 3,231,880 to Stein.

Other efforts to avoid pinching of the passenger during door closure has led to a proposal that the latch include a blocking mechanism to block latching of the latch when a body part is detected in the door entry. A device of this type is shown in U.S. Pat. No. 6,143,918 to Wilbanks.

It has also been proposed to provide a proximity sensor mounted from a vehicle door to detect proximity of the door to an exterior obstacle and then actuate a solenoid to move a panel latch to a pair of disks mounted on a hinge pin to limit opening of the door to avoid striking the obstacle. A device of this type is shown in U.S. Pat. No. 7,175,227 to Menard.

Various checking devices have been proposed for temporarily immobilizing doors at various selected angular locations during the manufacturing process, one such device includes door and pillar hinge brackets rotatable relative to one another for insertion of a spring intended to be compressed by movement of the door to return the door to selected positions. A device of this type is shown in U.S. Pat. No. 7,585,013 to Brown.

It has been proposed to provide a mechanism intended to interconnect between a hinge pin and door frame including a moveable element such as a circular ring or elongated strap formed with spaced apart bores for selective receipt of a plunger from a solenoid to control the position of the door in different angular open positions. A device of this type is shown in US Patent Application No. 2008/0309120 to Kohlstrand.

In effort to satisfy the need for a hold open means for a vehicle door, it has been proposed to provide a torsion bar to work in conjunction with a rather complex hinge construction acting through a star roller. A device of this type is shown in U.S. Pat. No. 3,370,317 to Marchione.

Further efforts have led to a proposal for a door hinge construction incorporating a torsion bar somewhat like a leaf spring, carried from one door bracket to cooperate with rollers carried from the opposite door bracket. A device of this type is shown in U.S. Pat. No. 3,931,664 to Nakano. These torsion bars are relatively complicated, difficult to manufacture and assemble and do not always provide for positively holding the door in its open position.

Even further efforts have led to the proposal that a roller be mounted on a hinge bracket to roll along the surface of a contoured leaf spring during the door opening procedure to purportedly hold the door in its open position as the roller rolls off the distal extremity of the spring. A device of this type is shown in U.S. Pat. No. 4,532,675 to Salazar. Devices of this type are also relatively expensive to manufacture, install and, further, would seem to be of questionable value for positively holding the door in its open position.

Despite the existence of these various door control and checking mechanisms, a problem exists with reliably positioning doors in their open position to, while a passenger is entering or leaving the vehicle to thus avoid the door accidentally swinging towards the closed position and striking the passenger, children or any other load such as groceries which might be carried in the passenger's arms. It is this need to which the present invention is directed.

### SUMMARY OF THE INVENTION

Hinge control arms interconnected between a vehicle pillar and the door and including a detent and lock mechanism for selectively locking the door in an open position. A sensor detects a passenger in the doorway to actuate the lock and is operative in response to absence of a passenger in such doorway to release the lock.

In one embodiment, I incorporate the expedient of merely forming the detent arm with a detent deeper than the OEM detent to be engaged by a cam or roller to positively hold the door in its open position to be locked in place to hold the door in its open position.

### BRIEF DESCRIPTION OF THE DRAWINGS

FIG. 1 is a horizontal, sectional view, partially broken away, of an OEM vehicle door hinge device including an arm with a detent which can be modified to receive the safety lock of the present invention;

FIG. 2 is a detail plan view of an OEM detent arm included in the device shown in FIG. 1 with a broken line to outline a deeper detent;

FIG. 3 is a detail plan view of the arm shown in FIG. 2 but with a deeper detent cut out;

FIG. 4 is a detail top-plan view of a detent arm included in the present invention;

FIG. 5 is a transverse sectional view, in enlarged scale, taken along the line 5-5 of FIG. 4;

FIG. 6 is a transverse sectional view, in enlarged scale, taken along the lines 6-6 of FIG. 4;

FIG. 7 is a horizontal sectional view similar to FIG. 1 showing a latch device included in the present invention and depicted in its latched position;

FIG. 8 is a partial, horizontal sectional view similar to FIG. 7 showing the latch device in its unlatched position; and

FIG. 9 is a partial prospective view of a car, incorporating a second embodiment of the present invention.

### DETAILED DESCRIPTION OF THE PREFERRED EMBODIMENTS

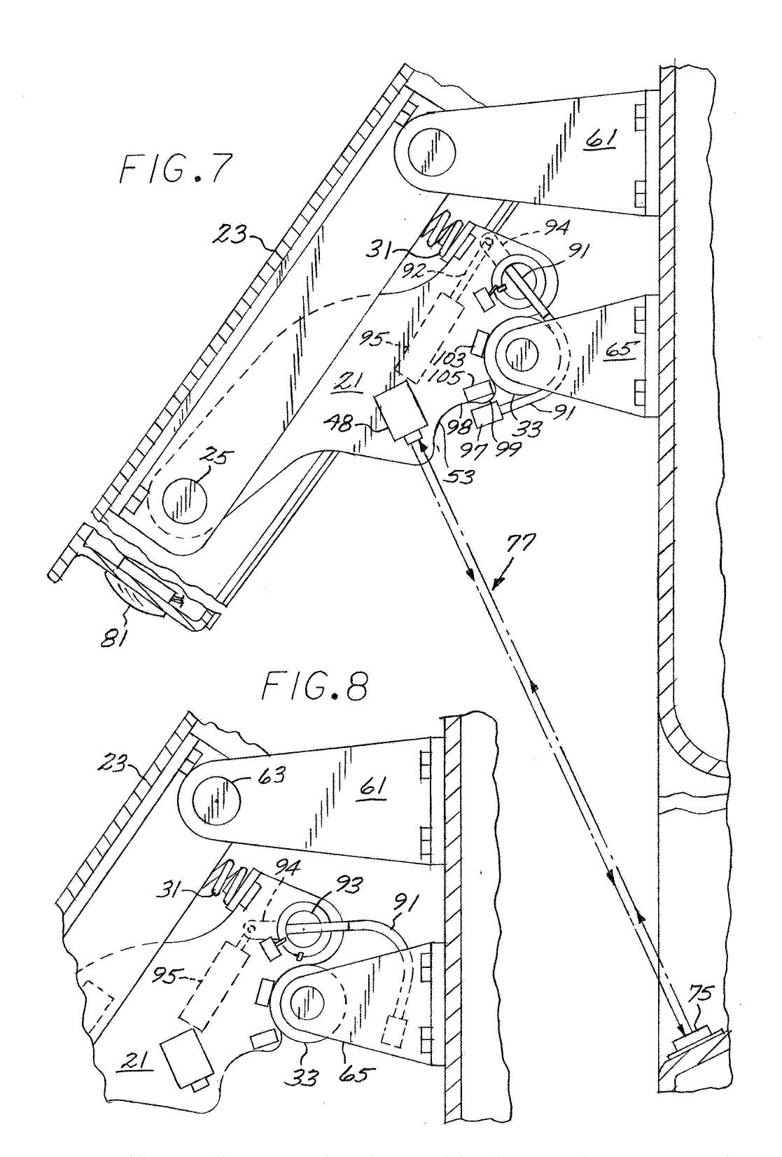

Referring the FIGS. 4, 7 and 8, the present invention includes, generally, a plate defining control arm 21 carried on one end from a door 23 via a pivot pin 25 and formed on one edge of its opposite extremity with a relatively deep detent 29. The free end of the control arm 21 is biased away from the door by means of a coil spring 31 and is configured to, when the door is in its open position, shown in FIG. 7, releasably engage a cam defined by a roller 33 on a cam-pin device 35. In the preferred embodiment, a latch is formed by a latch arm, generally designated 41, driven by a solenoid 43 operative in response to a sensor 48 sensing a passenger in the entry to the doorway to pivot a lock roller 33 into the detent 29 to positively prevent the door from closing.

Vehicle doors such as those incorporated in automobiles and particularly full-size automobiles are relatively heavy, on the order of 25-50 pounds, thus giving the door significant momentum when it swings toward its closed position. It is all too common an occurrence that a passenger entering or exiting a car door opening may be subjected to an accidental closing of the door as by a wind gust, an inclined position of the automobile or merely the momentum of the swinging door, resulting in striking of the passenger's arms and sometimes consequent injury and even dislodging an armload from the passenger or causing injury to an infant or the like carried by the passenger. One aspect of the door lock apparatus of the present invention is intended to be utilized with conventional vehicle doors or other door devices such as hood and trunk lids which may accidentally close on a workman working under the hood thus causing damage or injury.

Many automobiles incorporate a control or detent arm 51 (FIG. 1) carried on one end from a pivot pin 25 and formed on one side of its free extremity with first and second detents 53 and 55 intended to releasably engage a following roller 33 mounted to the door frame to releasably hold the door in a partially open or fully open positions, respectively. The door 23 itself is typically carried from a hinge bracket 61 via pivot pin 63. A cam bracket, generally designated 65, mounts the cam-pin 35. These detents are necessarily relatively shallow so that the roller will easily disengage when it is desirable to close the door. Thus, anytime the vehicle is parked on a slope or a gust of wind strikes the door there is the risk it will swing closed with significant momentum striking any passenger or other object in its path. It is this problem to which one aspect of the present invention is addressed.

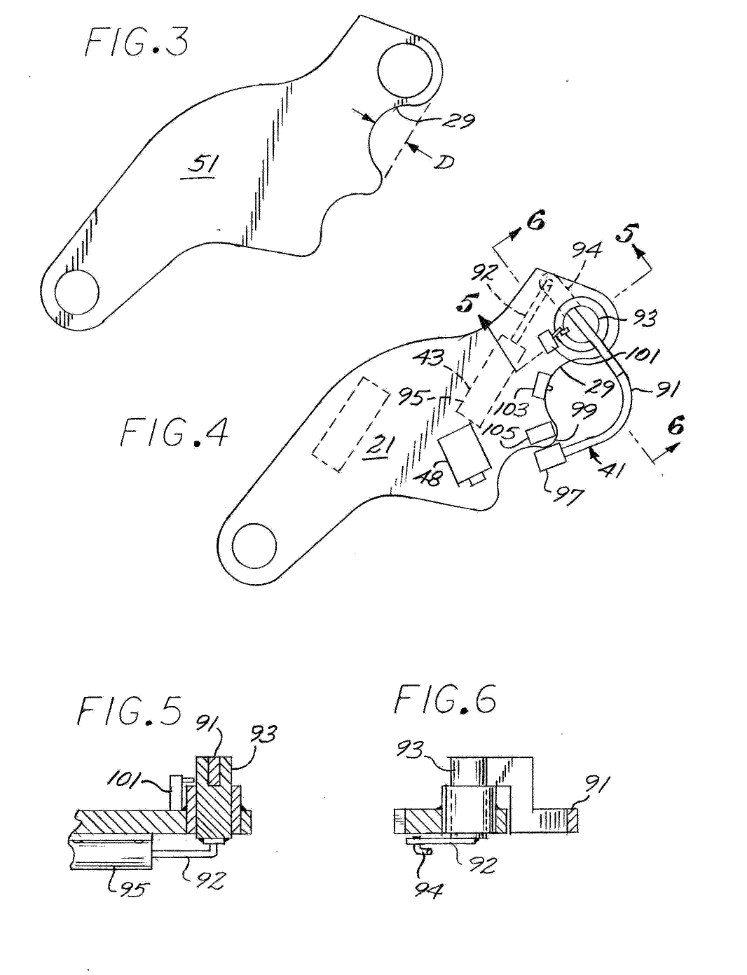

I have found that in one embodiment of my invention, an expedient is to modify the open door detent 55 to form the deep cut detent 29 to, when in the roller 33 is in the locked position, provide greater resistance to dislodgment of the roller to prevent the door swinging closed. In this regard, while various detent arms of different cars have different configurations, in one embodiment, I discovered that the OEM detent 55 may be cut deeper to form the detent 29 (FIGS. 3 and 4) to have depth D at least as great as the diameter of the roller 33 as to receive the roller fully recessed in the detent to be positively retained therein by a retainer or safety arm.

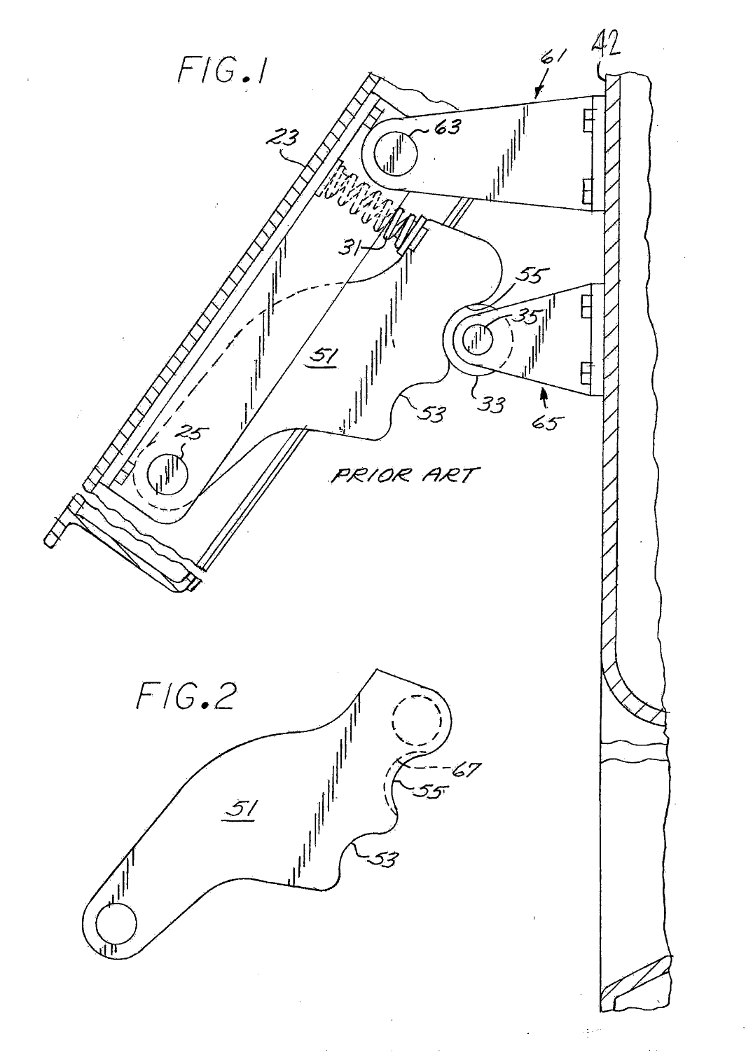

For my exemplary embodiment, I modify the control arm 51, as by grinding the detent 55 deeper into the control arm as indicated by the broken lines 67 in FIG. 2 to form a deep set detent 29.

In one embodiment I incorporate an electro-magnetic sensor in the form of a photo cell sensor device 48 on the door or hinge to sense when an electromagnetic beam 77, reflected from a light reflector 75 on the door frame, is broken (FIG. 7) as by a passenger exiting the doorway.

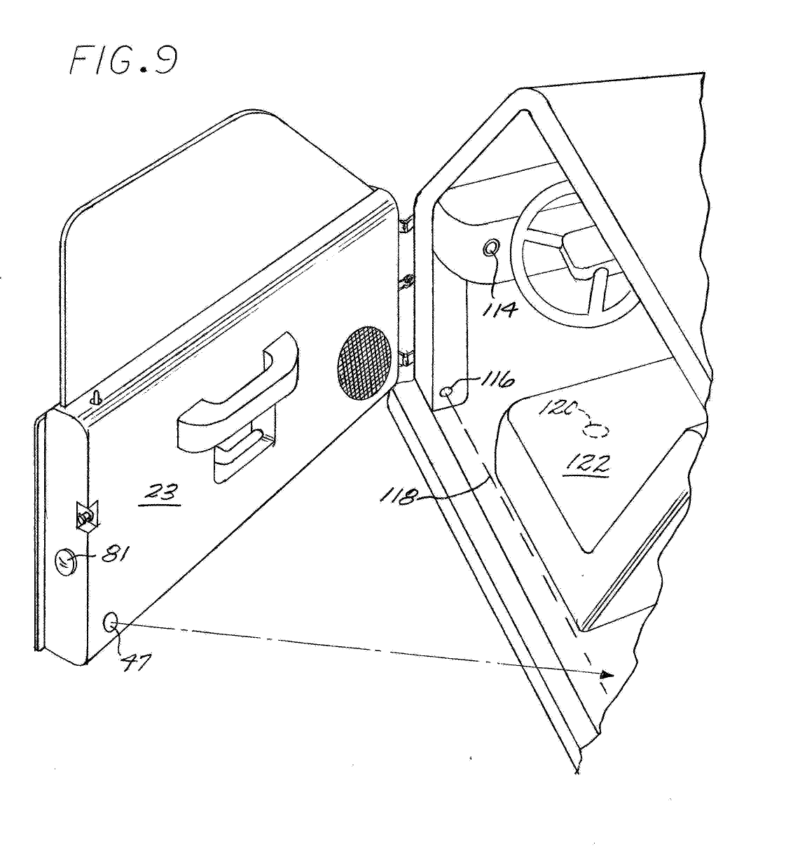

As will be appreciated, detection of the passengers presence in the doorway may be sensed by any one member of different motion sensors or the photo cell sensors 48. The photo cell device includes a traditional emitter positioned in any desired location on the door or door hinge to be aimed at a reflector 75 which, may also be located in any desired location along the door frame or on the seat frame or other location which will readily occur to one of skill As an example, referring to FIG. 9, the emitter 47 may be mounted on the lower edge of the free side of the door 23 to be aimed at the photo cell sensor. In any event, for the embodiment of FIG. 7, the light beam will be reflected from the reflector back to a receiver in the device 48. If interrupted, the latch mechanism will be released to free the door for movement.

Conveniently, and while not a critical part to the present invention, I incorporate a cluster of LED lights 81 on the open edge of the door to be energized with the solenoid circuit when the door is open so that oncoming traffic will be alerted to the fact that a stopped car door is open. In some embodiments, I incorporate a capacitor or other control to blink the LEDs on and off in rapid fashion.

Referring to FIGS. 7 and 8 in the preferred embodiment, the lock device includes an angularly shaped latch arm, 91, carried medially from a pivot pin 93 and formed on its proximal extremity with a rearwardly projecting crank 94 connected with a plunger 92 of a solenoid 95 mounted on the latch arm 91. The opposite end of the arm carries a latch 97 to cooperate with a latch receiver 98 on the detent arm to latch the arm in a latched position shown in FIG. 7. The safety latch itself can easily be at the end of the detent arm. It can be constructed as a unit for ease of manufacture and can be bolted or welded in place. The operator need not be concerned about releasing the safety lock as the sensors will automatically initiate this operation.

A sensor 103 senses nesting of the cam roller 33 in the detent 29. Further, a latch arm sensor 105 senses latching of the latch 97 in the receiver 98.

It will be appreciated that the safety latch arm 91 may take many different configurations and that by forming it with a gentle orthogonal curve it will fit numerous different sizes and shapes of detent pins and rollers incorporated in OEM door hinges. As an example, the latch may be in the form of a solenoid mounted on the pin bracket 65 and configured with a plunger to, when extended, push the roller 33 firmly in the detent 29. In other embodiments the latch arm remains cantileverly mounted and includes a latch pull at its pivot end to latch the arm in its latching position.

In operation, as will be appreciated by those skilled in the art, the locking device of the present invention may conveniently be incorporated as original equipment on a vehicle or may be easily added as a modification. The solenoid 95 and sensors 101, 103 and 105 will be connected in circuit with the passenger and sensor 48. When, for instance, a car door is opened, the detent arm 21 will be carried bodily outwardly with the door 23 with the free end biased clockwise about the pivot pin 25 by the spring 31 as viewed in FIG. 1.

As a passenger exits the vehicle or, in the case of a hood or trunk lid, the workman removes himself or herself from the work area under the lid, the sensor 48 will detect the passenger or workman. Then, as the roller 33 contacts the detent sensor 103 the current will be completed to convert the signal from the sensor 45 to actuate the solenoid 95 to swing the latch arm 91 from the position shown in FIG. 8 to the latch position shown in FIG. 7. The arm 91 will thus be wrapped around the cam roller 33 to engage the latch elements 97 and 98 to latch the free end of the arm in place holding the roller 33 in the detent 29.

The latch sensor 105 is then operable to signal that the latch arm is latched. The latch arm 91 will thus hold the roller 33 captive in the detent 29 to positively hold the door 23 in its open position. The passenger will then be protected from accidental closing of the door as the exit procedure is completed even to the extent that the passenger might stumble or otherwise lose his or her balance and grab the door to steady himself or herself. This feature thus serves to eliminate the risk of the door accidentally swinging toward its closed position, as upon being hit by a gust of wind or as a result of the door being weighted toward its closed position due to the car being parked on an incline causing the weight of the door to tend to swing it toward the closed position.

Once the sensor 48 detects that the passenger is no longer in the doorway, the latch element 97 and receiver 98 will be released, and the latch arm solenoid 95 retracted to draw the latch arm crank 94 counter clockwise, as viewed in FIG. 4, to retract the latch arm to the retracted position shown in FIG. 8 to release the cam roller 33 so that it is free to travel up over the hump between the detents and allow the door 23 to be closed. Should the passenger return to the vehicle momentarily, it will be appreciated that the sensor 48 will again sense the presence of the passenger in the doorway and maintain the latch arm 91 in its latch position of FIG. 7 to prevent unwanted closure of the door 23.

Referring to FIG. 9, in one exemplary design my invention incorporates a weight sensor 120 mounted in the driver's seat 122 and connected in circuit with the other components. The sensor normally maintains an open current but is operable upon application of a predetermined weight to the seat (for instance 50-70-pounds) to arm, as an optional feature, a system for operation when the sensor is un-weighted detecting egress of the passenger.

With continued reference FIG. 9, in some embodiments, I include an override system as, for example, a computer program or manual shut-off 114 operative to by-pass the entire system in the case of an electrical failure so the car door will be released to be closed in the normal manner.

Also, in some embodiments, I may delete the weight sensor and may also incorporate a sensor responsive to a passenger's foot, thigh or leg passing through a beam over the kickboard on entry to operate a bypass switch element in the circuit to enable the passenger to close the door without delay. To illustrate, in FIG. 9 I show a photo cell device 116 on the front of the car door frame to project a beam 118 to reflect off a reflector on the door frame at the latch side of the door. Thus, as the passenger enters the vehicle, breaking to beam 118, the circuit will be bypassed to enable to passenger to close the door without delay.

As will be appreciated by those skilled in the art, the present invention will provide additional safety for the transport of passengers, as when a passenger such as a child hits the door open causing it to fly to its full open position often resulting in it crashing back toward the closed position inflicting injury on the child. The device may be mounted on passenger vehicles, trucks, busses, vans, big rigs, fire trucks, police cars or any other vehicle that incorporated a pin door hinge.

From the foregoing, it will be appreciated that the lock device of the present invention provides a straight forward and secure system for locking the door in the open position to provide for the safety of the passenger or workman. In some embodiments, the device can be operated manually by a switch and in other embodiments the device will be automatically operated by means of a sensor sensing the presence of a passenger in the passenger door or under the drunk lid or the hood lid.

For the purposes of this disclosure, the term control arm or detent arm means any arm which includes any type of detent such as a cam surface, through bore, or blind bore for cooperating with a pin or cam which can be selectively received in the detent. It will be appreciated by those skilled in the art, the control arm or detent arm and the roller cam may be reversed such that a detent arm is carried from the frame and the roller cam is carried from the door itself.

For the purpose of this disclosure, the biasing device can mean any type of biasing spring, such as a coil spring, leaf spring, hydraulic piston or solenoid or the like. The passenger sensor 48 may be any type of object sensor, such as a motion sensor, photo cell or any other electromagnetic sensor responsive to the presence of an object presenting itself in the field of the active space for a passenger or workman ingressing or egressing from the active space.

Although the present invention has been described in detail with regard to the preferred embodiments and drawings thereof, it should be apparent to those of ordinary skill in the art that various adaptations and modifications of the present invention may be accomplished without departing from the spirit and the scope of the invention. Accordingly, it is to be understood that the detailed description and the accompanying drawings as set forth hereinabove are not intended to limit the breadth of the present invention.

1. Automatic vehicle door lock apparatus for locking a hinged door in an open position when the egress area between the door and doorway is occupied by a passenger and comprising:
a hinge arm pivotally connected between a hinged door device and a car door pillar device;
an elongated detent arm carried pivotally on one end from one of the devices and pivotal from a release to a stop position, the arm configured with a free extremity and a stop detent;
biasing means biasing the detent arm to the stop position;
a lock pin device carried form the other one of the devices and configured to be received in the stop detent;
a lock device for shifting between a release position and a lock position to lock the pin device in the detent;
a sensor for sensing the presence of an object in the egress area for generating the lock signal; and
an actuator device responsive to the lock signal for actuating one of the devices to shift the lock device to the lock position locking the pin device in the detent.

2. The automatic vehicle door lock apparatus of claim 1 that includes:
a lock pin sensor for sensing when the lock pin is in the detent for generating a detent signal; and
an actuator device responsive to the presence of both the actuator and detent signals to actuate the lock device.

3. The automatic vehicle door lock apparatus of claim 1 wherein:
the lock device includes a latch carried from the detent arm and shiftable from a release to a latching position to hold the pin in the detent.

4. The automatic vehicle door lock apparatus of claim 1 that includes:
a lock sensor responsive to lock the latch device in the unlatched position.

5. The automatic vehicle door lock apparatus of claim 1 that includes:
a latch device for selectively latching the lock device in its locking position.

6. The automatic vehicle door lock apparatus of claim 1 that includes:
a locking sensor responsive to the locking device being positioned in the locking position to generate a locking signal; and
a latch responsive to the locking signal to latch the locking device in the locking position.

7. The automatic vehicle door lock apparatus of claim 1 wherein:
the detent arm is configured with an edge in which the detent is formed to leave projections on the diametrical opposite sides;
the detent having a depth of substantially ½ inch from an imaginary line drawn between the extents of the respective projections.

8. The automatic vehicle door lock apparatus of claim 1 wherein:
the actuator includes an electric solenoid operative in response to the lock signal; and
the apparatus further includes an electromagnetic sensor device arranged to face the egress area when the door is open, the electromagnetic sensor device being connected in circuit with the solenoid and operative in response to the detection of an object in the egress area to generate a lock signal.

9. A lock apparatus to be connected between the hinge of a door and a frame defining a doorway and comprising:
a detent arm device and registration device interposed between the edge of the door and frame and including a detent arm device shiftable from a release to a lock position, the arm including a detent and a registration device including a registration pin device registerable in the detent when the arm is in the lock position;
mounting means mounting the detent arm and registration device between the door and frame for, upon opening of the door, travel of the detent through a path engaging the detent;
a device to urge the detent arm toward the pin;
a latch device for latching the registration pin device in the detent; and
an actuator for actuating the latch.

10. The lock apparatus of claim 9 wherein:
the latch device includes a latch arm shiftable into a retaining position against the pin device.

11. The lock apparatus of claim 9 that includes:
a sensor operative when the door is open to detect a person disposed between the open side of the door and frame and responsive to the detection of the person to generate an actuation signal; and
the actuator is responsive to the actuating signal to actuate the latch.

12. The apparatus of claim 9 that includes:
the device to urge the detent arm towards the pin includes a coil spring.

13. The lock apparatus of claim 9 wherein:
the actuator includes a solenoid.

14. The lock apparatus of claim 9 wherein:
the latch device includes a latch arm pivotally carried on one end from the detent arm formed on the opposite extremity with a free end and configured to, when the pin device is in the detent, wrap around the pin; and
a latch element for latching the free end of the latch arm to the detent arm.

15. A door control apparatus comprising:
a door hinged on one side to a door frame for opening at a free side;
a sensor operative in response to sensing of a person disposed between the door and free side to generate an actuating signal;
a door control device interposed between the door and the frame, including a detent arm and detent pin device, the arm being shiftable through a predetermined path upon opening of the door to engage the pin device in the detent; and
an actuator responsive to the actuating signal to latch the pin in the detent.

16. The apparatus of claim 15 that includes:
a device urging the pin and detent arm together.

17. The apparatus of claim 15 that includes:
a latch mounted for the detent arm and openable upon the engagement of the pin in the detent to latch the pin captive in the detent.

18. The apparatus of claim 17 wherein:
the latch includes an elongated latch arm carried pivotally on one end from the detent arm; and
a solenoid for moving the latch arm between a latching and unlatching position.

19. The apparatus of claim 15 that includes:
means responsive to the pin device engaging the detent for capturing the pin in the detent.

20. The apparatus of claim 15 wherein:
the sensor includes a photo cell.

21. Vehicle lock apparatus connected between a door edge and doorway of a vehicle and comprising:
a detent device connected with the door and including a detent shiftable when the door is opened through a path from a closed position to an open position, from a closed location to an open location;
a lock device mounted from the doorway and including a follower for following the detent device as the detent is carried through the predetermined path to, when the door is in the open position, engage the detent to hold the door in the open position; and
a latch device operative to hold the follower positively in the detent.
